(19) United States
(12) Patent Application Publication
(10) Pub. No.: US 2011/0163840 A1
(43) Pub. Date: Jul. 7, 2011

(54) HIGH RELIABILITY BLADE FUSE AND THE MANUFACTURING METHOD THEREOF

(75) Inventors: Xiurong Lu, Nanjing (CN); Xiaoming Cao, Nanjing (CN); Shirong Nan, Nanjing (CN); Manxue Yang, Nanjing (CN)

(73) Assignee: Nanjing Sart Science & Technology Development Co., Ltd.

(21) Appl. No.: 13/063,985

(22) PCT Filed: Oct. 23, 2009
(86) PCT No.: PCT/CN09/01182

§ 371 Date: Mar. 15, 2011

(30) Foreign Application Priority Data
Oct. 28, 2008 (CN) 200820186828.0
Nov. 25, 2008 (CN) 200810235439.7

(51) Int. Cl. H01H 85/06; H01H 69/02

(52) U.S. Cl. 337/296; 29/623

(57) ABSTRACT

The invention relates to the field of fuses, and particularly to a blade fuse used to protect electronic components and its manufacturing method. The said blade fuse comprises a ceramic substrate, a first metal layer, a second metal layer, an encapsulating layer, back electrodes and metal ends, wherein an insulating layer is between the first metal layer and the second metal layer, and the softening point of the insulating layer is between the melting points of the first and second metal layers; the method of manufacturing the said blade fuse includes the following steps: forming back electrodes on the back side of the substrate and then forming the first metal layer on the substrate in accordance with the pattern of the fuse wire; securing a metal mesh on the substrate, covering the two ends of the first metal layer, and forming the insulating layer with vapor deposition; removing the metal mesh, printing the second metal layer on the insulating layer with screen-printing technology and then covering all the surface of the substrate with the protective layer except its two ends wherein end electrodes are located so that the fuse wire is protected; the finished product is obtained after formation of end inner electrodes and end electrodes at last; the manufacturing processes disclosed in this invention is simple, and the blade fuse manufactured thereby is characteristic of excellent fusing performance, strong anti-aging capability and the smoother fusing curve.

### FIELD OF TECHNOLOGY

This invention relates to the field of fuses, and particularly to a blade fuse used to protect electronic components and its manufacturing method.

### BACKGROUND

There are three types of blade fuses in terms of prior manufacturing methods, namely, the monolithic-structure method, the wire-threading method whereby the metal wire is threaded through an insulating body, and the chip-resistor method. The monolithic-structure method refers to the method whereby thick film printing is adopted to form a single or multiple layers of fuse wire on the green body of a ceramic substrate. The substrate thereafter is subject to horizontal and vertical cutting in order to form the green bodies of independent members, which turn into finished products after undergoing such processes as cofiring, end encapsulation and electroplating. The fuse manufactured with this method presents high performance in arc distinguishing and desirable breaking capacity, but it also has defects such as long manufacturing duration and difficulty of making markings on the chip. With respect to the fuse manufactured with the wire-threading method, most often, the fuse wire is threaded through a hole within an insulating body made of ceramic. Two ends of the wire are thereafter connected to the two end electrodes respectively. The fuse manufactured with this method presents very high breaking capacity and desirable consistency, but also has obvious defects such as premature film-opening, and complicatedness and poor efficiency of wire-threading, both making it unsuitable for mass production. Compared with the two said methods, the chip-resistor method is a more maturely developed one. The basic processes of this method go as follows. First, providing a substrate with front and back sides, the horizontal and vertical cutting slots whereon divide the substrate into a plurality of rectangular units; forming front electrodes, back electrodes, fuse wire and a protective layer covering the fuse wire in succession on each said unit; cutting the substrate vertically to form a plurality of substrate strips, and thereafter forming inner electrodes on both end surfaces of each said strip; cutting each said strip horizontally along the cutting slots so that independent rectangular units are formed, and the blade fuses we need are therefore obtained. This method has been widely adopted due to its characteristics of simple manufacturing processes and short duration of each step, which consequently increases productivity and cuts down on manufacturing cost. There are three existing technologies to fulfill the chip-resistor method, namely, (1) the thick film technology whereby the fuse wire is screen-printed on the substrate directly, (2) the thin film technology whereby the fuse wire is formed on the substrate through such processes as surface deposition, electroplating, and photoetching, and (3) the multi-metal technology whereby the thick film technology is firstly adopted to form a particular pattern of the fuse wire on a substrate (a thermal barrier layer may be applied on the insulating substrate in advance), then after sintering the substrate, the thin film technology is adopted to form a second or even a third metal layer (layers are made of different metals) on the substrate. Since the multi-metal technology fully utilizes the alloying effect of the low-melting-point metal upon the high-melting-point metal during its melting, this technology can increase the fuse's capability against electrical surge and guarantee a quick break when overloaded. It is currently the most common technology used for fuse manufacture.

An embodiment of the said multi-metal technology is illustrated in FIG. 3, comprising an insulating substrate 100, two back electrodes 101 on the back side of the substrate, a thermal barrier layer 102 whose size is smaller than the size of the substrate, a second metal layer 103, a first metal layer 105 made of copper, the top layer 107 made of tin, a first protective layer 108, a second protective layer 109, end inner electrodes 110, and end electrodes 111.

The fuse manufactured with the said multi-metal technology undergoes the following steps:
I. Providing the substrate, its material being alumina;
II. Forming back electrodes: to form two back electrodes on both end of the back side of the substrate; the back electrodes are made of silver;
III. Forming the thermal barrier layer: to form the thermal barrier layer made of silicon rubber at the central place of the substrate, its size being smaller than the size of the substrate;
IV. Forming the second metal layer: to form the second metal layer made of titanium-tungsten alloy and copper on the front side of the substrate with thin film technology;
V. Forming the first photoresist layer: to form the first photoresist layer on the second metal layer;
VI. Exposing and developing: to apply exposing and developing processes on the first photoresist layer so that the first photoresist layer covering both two ends and the central place of the second metal layer is removed; therefore, the part of the second metal layer that is to engage with the first metal layer keeps uncovered;
VII. Forming the first metal layer: to put the substrate into the electroplating tank so that the first metal layer can be formed upon the second metal layer;
VIII. Removing the rest part of the first photoresist layer: to remove the rest part of the first photoresist layer that is useless thereafter so that the part of the second metal layer previously covered by the first photoresist layer is uncovered;
IX. Photoetching the second metal layer: to photoetch off the part of the second metal layer that is not covered by the first metal layer;
X. Forming the second photoresist layer;
XI. Exposing and developing: through exposing and developing, only the part of the second photoresist layer that covers two ends of the first metal layer remains while the central part of the first metal layer is completely uncovered;
XII. Forming the top metal layer: to form the top metal layer on the uncovered central part of the first metal layer by electroplating;
XIII. Removing the second photoresist layer: to remove the rest of the second photoresist layer;
XIV. Forming the first protective layer: to form the first protective layer with silicon rubber, the first protective layer at least covers the metal layers of the fuse;
XV. Forming the second protective layer: to form the second protective layer with ethoxyline resin;
XVI. Forming end inner electrodes: to form end inner electrodes at both left and right ends of the substrate by sputtering deposition.
XVII. Forming end electrodes: to form end electrodes by barrel plating.

One fatal defect of the fuse manufactured with the said multi-metal technology is quick aging. In view of intimate contact between the copper layer and the tin layer, mutual diffusion occurs inevitably. Diffusion correlates positively with time and temperature, that is to say, it turns to more active along with the increase of working time and temperature. Since the fuse wire releases a considerable amount of heat at its normal working state, and even more when a transient electrical surge attacks (which is not severe enough to make the fuse wire burn out immediately), the tin layer of the fuse wire will partly melt due to tin's low melting point. This partly melted tin results in tin's quicker diffusion into copper, whose melting point is higher. Over time, a copper-tin alloy layer between the tin and copper layers comes into being. Since copper-tin alloy has a comparatively lower melting point, it may cause an unexpected burn-out of the fuse even if a normal surge current passes. Though the formation of a layer of copper-tin alloy is an extreme assumption, the fuse wire's anti-surge capability does deteriorate along with such an assumed alloy-formation process.

Another defect of the fuse manufactured with the said multi-metal technology is that both tin and copper are involved in current distribution due to intimate contact between the tin layer and the copper layer. This is an unfavorable factor insofar as the fuse's consistency is concerned. Since thickness, width and evenness of the copper layer or the tin layer are subject to slight yet unavoidable variation during manufacture, and the only convenient way to test such a variation is to measure the cold resistance of the fuse, which, by the way, is exact the way we use to find out qualifying products among fuses of the same type, there exists a problem for the fuse wherein two metals are involved in current conduction. That is, though one fuse may have the same total resistance as the other, its copper resistance may bigger than that of the other while its tin resistance is correspondingly smaller than that of the other. As is known to all, copper are greatly different from tin in terms of its resistivity, density and heat conductivity, the “qualifying” fuses tested in terms of total cold resistance therefore may present considerable big difference insofar as their fusing features are concerned.

### SUMMARY

This invention is to provide a new method for manufacturing the blade fuse, and the fuse so manufactured presents such favorable fusing features as quick break and high pulse endurance, more importantly, it shows strong anti-aging capability and smoother fusing curve, which enables it to be used in equipments working in harsh environments, for example, aerospace or military equipments. Furthermore, the technical solution provided in this invention includes: a blade fuse, comprising a ceramic substrate 1, a first metal layer 2, an insulating layer 3, a second metal layer 4, an encapsulating layer 5, back electrodes 6 and metal ends; the first metal layer 2 and the second metal layer 4 is separated by an insulating layer, whose softening point is between the melting point of the first metal layer and the melting point of the second metal layer; since the two metal layers are separated by the insulating layer, mutual diffusion does not occur during the normal working state, which consequently avoid the quick aging process mentioned above; in addition, since the second metal layer is not involved in current distribution, the resistance measured in cold condition belongs exclusively to the first metal layer, therefore, the simple resistance-testing method mentioned above is enough to screen out qualifying fuses, and the fusing features of these fuses present higher consistency as well. The said metal ends include end inner electrodes 7, end electrodes (Ni) 8, and end electrodes (Sn) 9.

This invention also provides a method for manufacturing the blade fuse, wherein back electrodes are first formed on the substrate, then the screen-printing technology or the deposition plating and mask etching technology is adopted to form the first metal layer on the substrate in accordance with the designated pattern of the fuse wire; a layer of metal mesh is secured upon the substrate so that the two ends of the first metal layer are covered, and vapor deposition technology is thereafter adopted to form an insulating layer; after the metal mesh being removed, the second metal layer is screen-printed on the insulating layer; the protective layer is introduced to cover the substrate except the part wherein the two end electrodes are located so that the fuse wire on the substrate is protected; after the last step of forming end inner electrodes and end electrodes, the finished products are available.

In this invention, the material used for the first metal layer is silver, copper or gold. The insulating layer is 1-5 μm in thickness, made of metallic oxides or their mixture characteristic of high heat conductivity and high insulativity. The softening point of the metallic oxides or their mixture is lower than the melting point of the first metal layer but higher than the melting point of the second metal layer. The material used for the second metal layer is tin, and the patterning of the second metal layer overlaps partly with that of the first metal layer in plan view. The material used for the protective layer is glass paste, silicon resin, polyamide or ethoxyline resin.

Compared with prior methods, the method disclosed in this invention is characteristic of simpler processes and significant reduction in manufacturing cost.

In this invention, the thick film printing technology is adopted to form the first metal layer; compared with photoetching, this technology is simpler, more efficient, and its control accuracy, which is no lower than photoetching, is enough for manufacturing the fuse.

The blade fuse obtained with the method disclosed in this invention works under the following main principles: with increase of overload time or overload intensity, the first metal layer generates heat; when its temperature goes up to the softening point of the insulating layer, the insulating layer is breached and the tin in the second metal layer, which has heretofore been melting, floods into the first metal layer; the melting tin causes immediate burn-out of the first metal layer, the circuit is therefore protected.

### BRIEF DESCRIPTION OF THE DRAWINGS

FIG. 1 is a flow diagram showing an embodiment of the manufacturing method disclosed in this invention;

FIG. 2 is a structure diagram showing an embodiment of the blade fuse manufactured with the method disclosed in this invention, wherein 1 the substrate, 2 the first metal layer, 3 the insulating layer, 4 the second metal layer, 5 the encapsulating layer, 6 back electrodes, 7 end inner electrodes, 8 end electrodes (Ni), 9 end electrodes (Sn);

FIG. 3 is a structure diagram showing the multi-metal technology in prior methods.

### DETAILED DESCRIPTION

### Embodiment 1

### Manufacturing Processes of the Said Blade Fuse

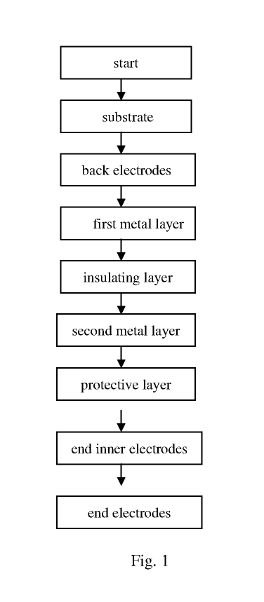

As is shown in FIG. 1, the manufacturing processes go as follows:

I. Providing the Substrate 1, which is Mainly Made of Alumina or Steatite;

II. Patterning the Back Electrodes
A conductive paste, which contains silver, is screen-printed on both ends of the back side of the substrate 1 to form the pattern of the back electrodes 6;

III. Drying the Substrate in a Drying Oven (Temperature: 150° C. Time: 15 Min)

IV. Forming the Front Electrodes

The front electrodes 2 are screen-printed on the front side of the substrate 1, the conductive paste contains silver;

V. Drying the Substrate in a Drying Oven (Temperature 150° C. Time: 15 Min)

VI. Sintering the Substrate in a Sintering Oven (Maximal Temperature: 600° C.-850° C. Time: 60 Min)

VII. Patterning the Fuse Wire;
A conductive paste is screen-printed on the ceramic substrate to form the fuse wire between the two front electrodes. The two ends of the fuse wire are connected to the two front electrodes respectively so that an electrical continuity between the fuse wire and the front electrodes is built up. The pattern of the fuse wire can be a straight line, a serpentine line or a line in any other forms. The main components of the conductive paste are some conductive metals, such as silver, palladium, copper and platinum, or their mixture.
The fuse wire can be designed together with the two electrodes so that an integral H-shaped pattern will be formed during a once-through printing process.
To make our demonstration easier, the combination of the fuse wire and the front electrodes are thereafter referred to as the front electrode, a.k.a. a front electrode with an “H” shape.

VIII. Sintering the Substrate in a Sintering Oven (Maximal Temperature: 600° C.-850° C. Time: 60 Min)

IX. Forming the Insulating Layer
After a metal mesh being secured thereupon, the substrate 1 is subject to a vapor deposition process so that a thin layer of oxides is formed on the substrate 1 and the front electrode 2.

X. Forming the Second Metal Layer
The second metal layer 4, which is made of tin, is screen-printed on the insulating layer 3; the size of the second metal layer is smaller than the size of the insulating layer.

XI. Forming the Protective Layer (Encapsulating Layer 5)
A protective layer (made of ethoxyline resin or phenolic resin) is screen-printed on the substrate that has been printed with several patterned layers as mentioned above; the protective layer is shorter than the ceramic substrate in length and is printed at the central place thereof, the front electrode therefore remains uncovered.

XII. Forming End Inner Electrodes
The inner electrodes 7 made of Ni—Cr alloy are sputtered on both left and right ends of the substrate 1;

XIII. Forming End Electrodes
The end electrodes 8 and 9 made of nickel and tin respectively are barrel-plated on, covering back electrodes, the front electrode and end inner electrodes.

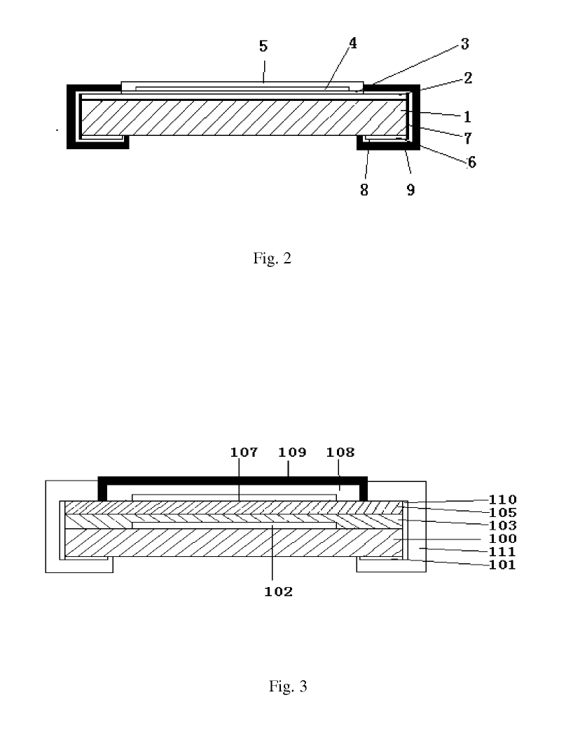

The structure of the blade fuse manufactured through the said processes is illustrated in FIG. 2, comprising the ceramic substrate 1, the first metal layer 2, the insulating layer 3, the second metal layer 4, the encapsulating layer 5, back electrodes 6 and metal ends.

### Embodiment 2

The products [S 1206-V-2A] manufactured through Embodiment 1 are tested in accordance with testing items and technical requirements stipulated in Chinese national standards GB9364.4-2006 and GB9364.1-1997. The results show that these products completely satisfy the stipulated specifications, particularly, compared with the products manufactured with the conventional multi-metal technology, these products present significant improvement insofar as the anti-aging capability is concerned. When being subject to 2 times and 10 times rated current, the breaking-time variation of these products is much lower than that of the fuses manufactured with conventional multi-metal technology. The test results of the fuses manufactured with the two different technologies are compared as follows:

TABLE 1
comparison of anti-aging capability

| | fuses made with conventional | | fuses made with technology | |
|---|---|---|---|---|
| | multi-metal technology | | disclosed herein | |
| | 2 In breaking | 10 In breaking | 2 In breaking | 10 In breaking |
| No. | time (mS) | time (μS) | time (mS) | time (μS) |
| 1 | 12.15 | 820 | 14.43 | 880 |
| 2 | 16.17 | 690 | 15.32 | 920 |
| 3 | 14.35 | 790 | 15.44 | 930 |
| 4 | 32.32 | 480 | 15.87 | 880 |
| 5 | 14.65 | 780 | 13.25 | 900 |
| 6 | 18.90 | 1020 | 15.88 | 820 |
| 7 | 28.78 | 280 | 17.67 | 1000 |
| 8 | 20.66 | 900 | 13.26 | 790 |
| 9 | 4.56 | 900 | 12.56 | 730 |
| 10 | 23.55 | 440 | 13.77 | 820 |
| time | 27.26 | 580 | 5.11 | 270 |
| range | | | | |

Note:
the anti-aging test is conducted as follow: choosing 20 fuses from each group and loading with the rated current for 200 hours (temperature 30° C., humidity 60%), thereafter testing the breaking time of these fuses with 2 times and 10 times rated current respectively.

Instruments used for this test are BXC-35A fusing testing device, DS5062M digital oscilloscope, and HWS-08A high-temperature high-humidity constant temperature oven.

1-8. (canceled)

9. A high reliability blade fuse, comprising:
a ceramic substrate, a first metal layer, a second metal layer, an encapsulating layer, a plurality of back electrodes and a plurality of metal ends, wherein there exists an insulating layer between the first metal layer and the second metal layer, and a softening point of the insulating layer is between the melting points of the first metal layer and the second metal layer.

10. The high reliability blade fuse as defined in claim 9, wherein the first metal layer is made of at least one of silver, copper and gold.

11. The high reliability blade fuse as defined in claim 10, wherein the insulating layer is 1-5 μm in thickness and made of metallic oxides or their mixture characteristic of high heat conductivity and high insulativity, further wherein the softening point of the insulating layer is lower than the melting point of the first metal layer but higher than the melting point of the second metal layer.

12. The high reliability blade fuse as defined in claim 11, wherein the material of the second metal layer is tin.

13. A method for manufacturing the high reliability blade fuse as defined in claim 9, comprising:
forming the plurality of back electrodes on a back side of the ceramic substrate;
forming the first metal layer on the ceramic substrate with at least one of screen-printing technology and deposition plating and mask etching technology in accordance with a pattern of a fuse wire;
securing a metal mesh on the ceramic substrate and covering the two ends of the first metal layer;
depositing the insulating layer thereon;
removing the metal mesh and printing the second metal layer on the insulating layer with screen-printing technology;
covering the entire surface of the ceramic substrate with the protective layer except that of two ends wherein end electrodes are located so that the fuse wire is protected;
wherein the finished product is obtained after formation of end inner electrodes and end electrodes at last.

14. The method for manufacturing the high reliability blade fuse as defined in claim 13, wherein the first metal layer is made of at least one of silver, copper and gold.

15. The method for manufacturing the high reliability blade fuse as defined in claim 14, wherein the insulating layer is 1-5 μm in thickness and made of metallic oxides or their mixture characteristic of high heat conductivity and high insulativity, further wherein the softening point of the insulating layer is lower than the melting point of the first metal layer but higher than the melting point of the second metal layer.

16. The method for manufacturing the high reliability blade fuse as defined in claim 15, wherein the second metal layer is made of tin.
